(19) United States
(12) Patent Application Publication
(10) Pub. No.: US 2008/0135160 A1
(43) Pub. Date: Jun. 12, 2008

(54) Sheet processing method and image forming apparatus

(76) Inventors: Yukiko Iwasaki, Yokohama-shi (JP); Kazuhisa Sudo, Kawaseki-shi (JP); Mikio Ishibashi, Yokohama-shi (JP); Megumi Ohtoshi, Kawasaki-shi (JP); Reki Nakamura, Segamilhere-shi (JP); Masafumi Yamada, Kawasaki-shi (JP); Toshihiro Sugiyama, Tokyo (JP); Nobuyuki Koinuma, Yokohama-shi (JP); Takashi Sakamaki, Ebina-shi (JP)

Correspondence Address: HARNESS, DICKEY & PIERCE, P.L.C., P.O. BOX 8910, RESTON, VA, 20195, US

(21) Appl. No.: 11/978,607

(22) Filed: Oct. 30, 2007

(30) Foreign Application Priority Data
Nov. 6, 2006 (JP) 2006-300916
Jun. 21, 2007 (JP) 2007-164108

(51) Int. Cl. B32B 37/18; B32B 37/00; G03G 15/20; B32B 37/12

(52) U.S. Cl. 156/227; 156/60; 156/327; 399/328

(57) ABSTRACT

A sheet processing method including superimposing a transparent sheet having a mirror image thereon on a non-transparent sheet so that a surface of the transparent sheet having the mirror image faces the non-transparent sheet with an adhesive medium therebetween. An image forming apparatus includes an image forming means for forming a mirror image on a transparent sheet, and a heating and pressing means for applying heat and pressure to the transparent sheet and a non-transparent sheet on which the transparent sheet is superimposed so that a surface of the transparent sheet having the mirror image faces the non-transparent sheet. The non-transparent sheet includes a heat-sensitive adhesive layer including an adhesive medium including a thermoplastic resin and a solid plasticizer, on a surface facing the surface of the transparent sheet having the mirror image.

### PRIORITY STATEMENT

The present patent application claims priority from Japanese Patent Applications Nos. 2006-300916, filed on Nov. 6, 2006 in the Japan Patent Office, and 2007-164108, filed on Jun. 21, 2007 in the Japan Patent Office, the entire contents of each of which are hereby incorporated herein by reference.

### BACKGROUND OF THE INVENTION

1. Field of the Invention

Example embodiments generally relate to a sheet processing method and/or an image forming apparatus, for example, for forming a high-quality image on a recording medium used for digital printing using an electrophotographic method.

2. Description of the Related Art

A related-art image forming apparatus, such as a copying machine, a facsimile machine, a printer, or a multifunction printer having two or more of copying, printing, scanning, and facsimile functions, forms a toner image on a recording medium (e.g., a sheet) according to image data by an electrophotographic method. In such a method, for example, a charger charges a surface of an image carrier (e.g., a photoconductor). An optical device emits a light beam onto the charged surface of the photoconductor to form an electrostatic latent image on the photoconductor according to image data. The electrostatic latent image is developed with a developer (e.g., a toner) to form a toner image on the photoconductor. A transfer device transfers the toner image formed on the photoconductor onto a sheet. A fixing device applies heat and pressure to the sheet bearing the toner image to fix the toner image on the sheet. The sheet bearing the fixed toner image is then output to an outside of the image forming apparatus.

Various attempts have been made to obtain a photographic image having an increased gloss. For example, one image forming apparatus uses a special toner for providing an increased gloss, in which, for example, a transparent toner is uniformly applied on a sheet bearing a toner image before the toner image is fixed on the sheet. After fixing, a photographic image is formed on the sheet.

However, in the above-described image forming apparatus, there is a problem that, for example, a heavy load is applied to a fixing unit because the transparent toner is always applied to the entire surface of the sheet and there is a difference in toner thickness between an image portion and a non-image portion of the sheet.

Another example image forming method uses a special recording medium for providing an increased gloss. For example, a recording sheet includes a thermoplastic resin layer on its front and/or back surfaces. After a toner image is fixed on the recording sheet, heat and pressure are further applied to the recording sheet bearing the toner image, so that the surface of the recording sheet may provide a uniform gloss.

However, the full effect of the above-described technology is only achieved when the recording sheet is used together with a special fixing device. Thus, there are problems in terms of a structure, cost, power consumption, and the like.

Yet another example image forming apparatus includes a fixing device including first and second fixing members to provide an increased gloss. After the first fixing member fixes a toner image on a sheet, the second fixing member including a smooth belt melts the toner image on the sheet again. The sheet bearing the toner image is cooled and separated from the belt. The smooth belt may impart a uniform gloss to the toner image on the sheet.

However, there are problems with this image forming apparatus as well in terms of a structure, cost, power consumption, and the like.

Another technique is proposed in which a transparent film including an adhesive layer is adhered to an image to provide a photographic-quality image. The adhesive layer is formed on the transparent film, and the transparent film is bonded to the image surface.

However, adhesion of the image to the transparent film is poor, and therefore it is impossible to reproduce a photographic-quality image.

Yet another technique is proposed in which a transparent film having a reversed image on the rear surface thereof is adhered to an optical retro-reflective sheet. An adhesive surface is provided on a surface of the optical retro-reflective sheet facing the print surface of the transparent film. The adhesive surface and the print surface are integrated to provide an image display plate.

However, the above technology is provided on condition that the optical retro-reflective sheet, on which it is difficult to print an image, is used. Since it is difficult to print an image on the retro-reflective sheet, the transparent film is used to form the image display plate. Therefore, it is not an object of the above technology to pursue photographic-quality imaging.

As an example of a heat-sensitive adhesive agent, a heat-sensitive adhesive agent having adhesion when heated, providing a high blocking performance, is proposed. However, such proposal does not examine a technology for obtaining a photographic image using a simple hardware configuration and providing satisfactory storage life.

### SUMMARY

At least one embodiment of the present invention provides a sheet processing method, in which a transparent sheet having a mirror image thereon and a non-transparent sheet are superimposed so that a surface of the transparent sheet having the mirror image faces the non-transparent sheet with an adhesive medium therebetween.

At least one embodiment provides an image forming apparatus for superimposing a transparent sheet having a mirror image thereon and a non-transparent sheet including a heat-sensitive adhesive layer including an adhesive medium including a thermoplastic resin and a solid plasticizer to form an image including a transparent layer, an image layer, and a non-transparent layer. The image forming apparatus includes an image forming means for forming a mirror image on the transparent sheet, and a heating and pressing means for applying heat and pressure to the transparent sheet having the mirror image thereon and the non-transparent sheet, which are superimposed, so that a surface of the transparent sheet having the mirror image faces the non-transparent sheet.

Additional features and advantages of example embodiments will be more fully apparent from the following detailed description, the accompanying drawings, and the associated claims.

### BRIEF DESCRIPTION OF THE DRAWINGS

A more complete appreciation of example embodiments and the many attendant advantages thereof will be readily obtained as the same becomes better understood by reference to the following detailed description when considered in connection with the accompanying drawings, wherein:

FIGS. 1A and 1B are plan views illustrating examples of a recording sheet including a transparent portion and a non-transparent portion at different ratios according to a first example embodiment;

FIGS. 2A to 2E are plan views illustrating a process of folding and conveying the recording sheet in which a surface of the transparent portion of the recording sheet having an image thereon and the non-transparent portion of the recording sheet including a heat-sensitive adhesive layer are bonded together to obtain a photographic image;

FIG. 3 is a schematic cross-sectional view illustrating a structure of an image forming apparatus according to the first example embodiment;

FIG. 4 is a plan view illustrating a process of folding back a mirror image to form a photographic image;

FIGS. 5A and 5B are cross-sectional views illustrating structures of the recording sheet after folding back and bonding;

FIG. 6 is a cross-sectional view illustrating a recording sheet having a toner image on the outermost layer thereof;

FIG. 7 is a cross-sectional view illustrating a structure of a sheet including the heat-sensitive adhesive layer;

FIG. 8 is a schematic cross-sectional view illustrating a structure of an image forming apparatus according to a second example embodiment;

FIG. 9 is a schematic cross-sectional view illustrating a structure of a bonding device of the image forming apparatus according to the second example embodiment; and

FIGS. 10 to 17 are enlarged sectional views illustrating examples of a process of bonding a transparent sheet to a non-transparent sheet.

The accompanying drawings are intended to depict example embodiments and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

Reference is now made to the drawings, wherein like reference numerals designate identical or corresponding parts throughout the several views thereof.

The following description refers to a sheet processing method and an image forming apparatus according to a first example embodiment. In a first example embodiment, a recording sheet includes a transparent portion and a non-transparent portion. After an image has been formed on the transparent portion, the recording sheet is folded, and heat and pressure applied so that a photographic image may be obtained thereon.

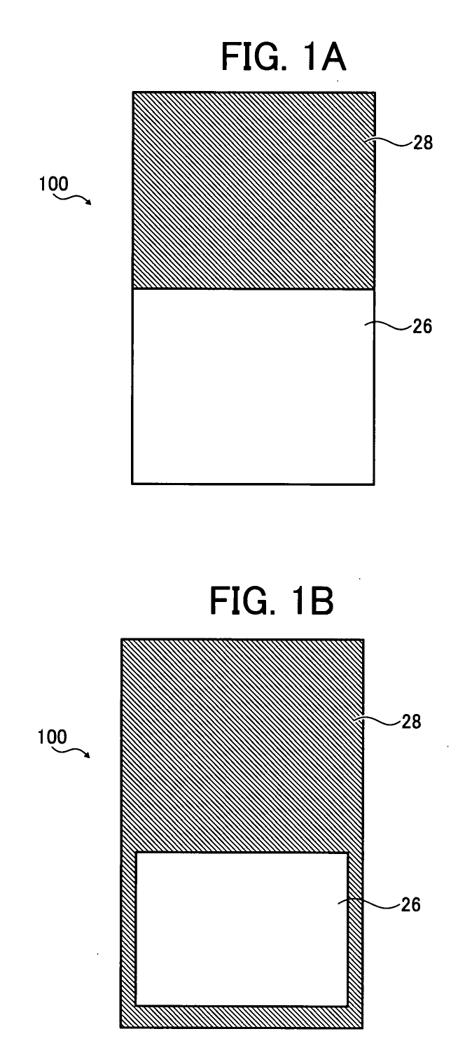

FIGS. 1A and 1B illustrate examples of a recording sheet 100 used in the first example embodiment. For example, as shown in FIG. 1A, the recording sheet 100 may include a transparent portion 26 in one half thereof and a non-transparent portion 28 in the other half. The non-transparent portion 28 of the recording sheet 100 is normally white for full-color photographic image printing. However, so long as it is opaque, the non-transparent portion 28 of the recording sheet 100 is not limited to being white. As shown in FIG. 1B, the recording sheet 100 according to the first example embodiment may include the transparent portion 26 in a part thereof.

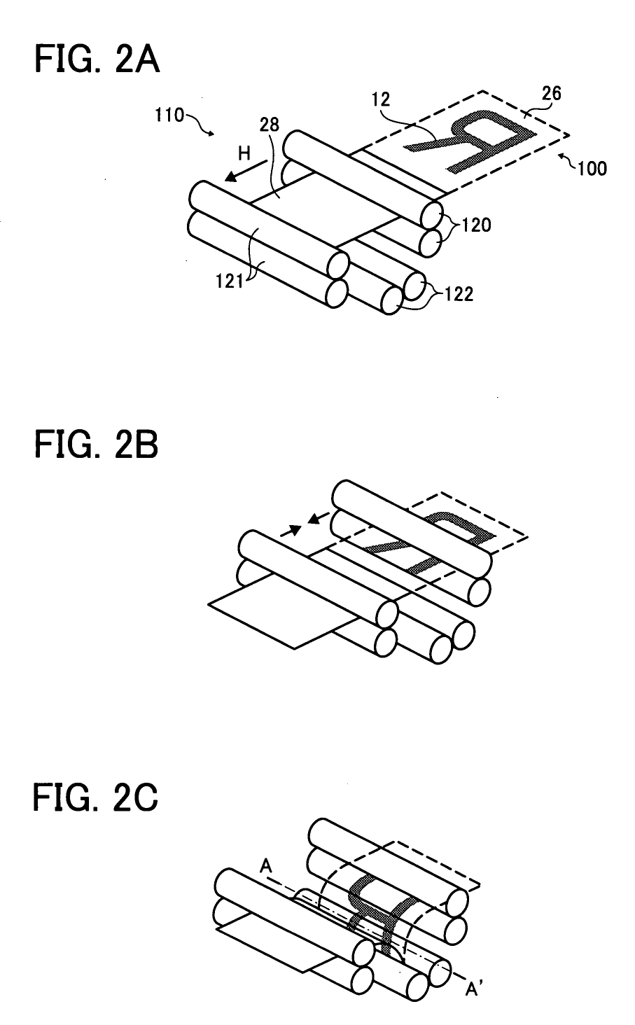

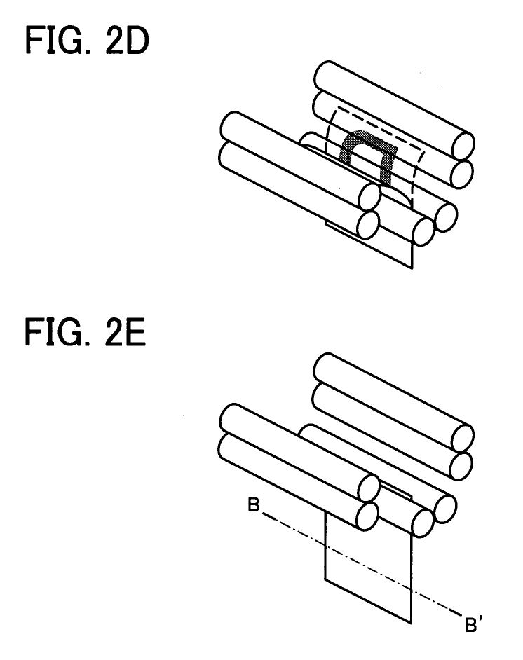

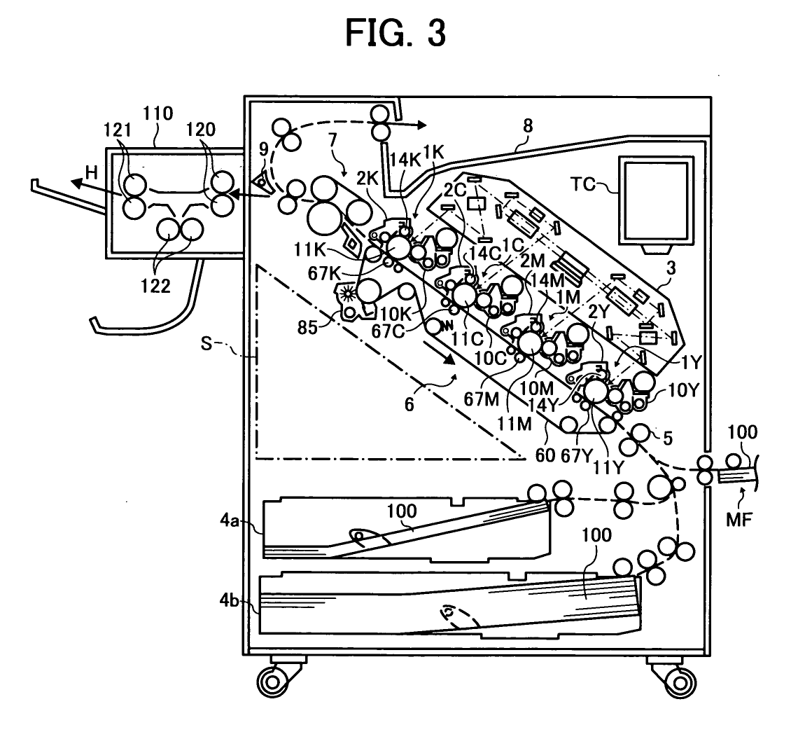

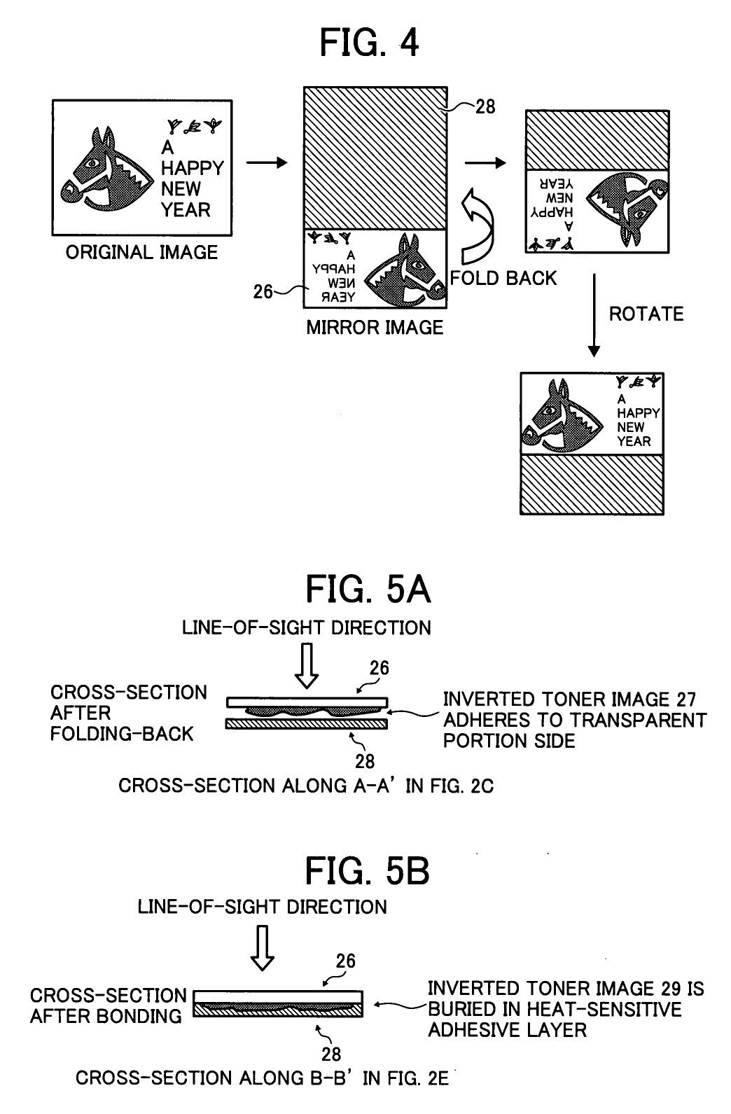

FIGS. 2A to 2E are plan views illustrating a process of superimposing and integrating the transparent portion and the transparent portion of the recording sheet to obtain a photographic image in a post-processing device 110 of an image forming apparatus according to the first example embodiment to be described later in FIG. 3. In processing steps shown in FIGS. 2A to 2E, the recording sheet having the transparent portion 26 in one half thereof and the non-transparent portion 28 in the other half shown in FIG. 1A is used. As shown in FIG. 2A, an original image 12 (an inverted image of an image “R”) is formed on the transparent portion 26 of the recording sheet 100. Either one of the transparent portion 26 and the non-transparent portion 28 of the recording sheet 100 includes a heat-sensitive adhesive layer thereon. In this embodiment, the non-transparent portion 28 includes a heat-sensitive adhesive layer thereon. After the image has been fixed onto the transparent portion 26, the recording sheet 100 is conveyed to the post-processing device 110. The image forming apparatus of the first example embodiment may include a separation pick 9 for switching the conveyance of the recording sheet 100 to either a discharge tray 8 or the post-processing device 110, to be described later in FIG. 3. In the post-processing device 110, the recording sheet 100 is conveyed in a direction indicated by an arrow H in FIG. 2A, and then a pair of rollers 121 are caused to reversely rotate at a predetermined timing (FIG. 2B), so that the recording sheet 100 is folded in half and is conveyed to a pair of rollers 122 (FIG. 2C). Thereafter, a pair of the rollers 122 apply pressure to the folded recording sheet 100, and output the recording sheet 100 (see FIGS. 2D and 2E).

The folded recording sheet 100 is output in a form including a toner image 27 between the transparent portion 26 and the non-transparent portion 28 as shown in FIG. 5 (to be described later).

In such a case, since the non-transparent portion 28 of the recording sheet 100 becomes a background portion, the non-transparent portion 28 is normally white for full-color photographic image printing. The non-transparent portion 28 including a heat-sensitive adhesive layer is superimposed on the transparent portion 26 so that the image formed on the transparent portion 26 faces the heat-sensitive adhesive layer formed on the non-transparent portion 28. Consequently, a photographic image may be obtained. In the first example embodiment, since the non-transparent portion 28 of the recording sheet 100 becomes a background portion, the non-transparent portion 28 is not particularly limited to white.

FIG. 3 is a schematic cross-sectional view illustrating a configuration of an image forming apparatus according to the first example embodiment. As shown in FIG. 3, the image forming apparatus includes four image forming units 1Y, 1M, 1C, and 1K which form images of respective colors of yellow (Y), magenta (M), cyan (C), and black (K). The order of arrangement of Y, M, C, and K is not limited to the arrangement shown in FIG. 3, and a different order may be applied.

The image forming units 1Y, 1M, 1C, and 1K respectively include photoconductive drums 11Y, 11M, 11C, and 11K serving as image carriers, charging means, development means, and cleaning means. Each of the image forming units 1Y, 1M, 1C, and 1K is arranged with a predetermined pitch in a conveyance direction of the recording sheet 100, and rotation axes of the photoconductive drums are parallel to each other.

An optical writing unit 3 including a light source, a polygon mirror, an f-θ lens, a reflection mirror, and so forth, is disposed above the image forming units 1Y, 1M, 1C, and 1K. The optical writing unit 3 irradiates a laser beam onto the surface of each of the photoconductive drums 11Y, 11M, 11C, and 11K based on image data while scanning the surface thereof with the laser beam. A transfer unit 6 serving as a belt driving device is disposed below the image forming units 1Y, 1M, 1C, and 1K. The transfer unit 6 includes a conveyance belt 60 for conveying the recording sheet 100 through a transfer part of each of the image forming units 1Y, 1M, 1C, and 1K while carrying the recording sheet 100. A cleaning device 85 including a brush roller and a cleaning blade is arranged on an outer peripheral surface of the conveyance belt 60 in a contact manner. The cleaning device 85 removes residual toner and so forth adhering to the conveyance belt 60.

A fixing unit 7 of a belt fixing system, a discharge tray 8, and so forth, are disposed at a side of the transfer unit 6. Paper feed cassettes 4a and 4b in which the recording sheet 100 is stored are provided in a lower part of the image forming apparatus. A manual paper feed tray MF for manually feeding the recording sheet 100 is provided to a side surface of the image forming apparatus. In addition, a toner supply container TC is disposed in the image forming apparatus, and a waste toner bottle, a duplex/inverting unit, a power supply unit, and so forth, all of which are not shown in the accompanying drawings, are included in a space S indicated by a chain double-dashed line.

Each of development devices 10Y, 10M, 10C, and 10K of a two-component development system serving as a development means, has a similar configuration, but uses a toner of a different color. The development devices 10Y, 10M, 10C, and 10K (hereinafter collectively referred to as the “development device 10”) store a developer including a toner and a magnetic carrier. The development device 10 includes a development roller provided opposite to each of the photoconductive drums 11Y, 11M, 11C, and 11K (hereinafter collectively referred to as the “photoconductive drum 11”), a screw for conveying and stirring the developer, a toner density sensor, and so forth. The development roller includes a rotatable sleeve on the outer side, and a magnet fixed on the inner side. A toner supply device supplies the toner based on data output from the toner density sensor.

Operation and effects of the image forming apparatus according to the first example embodiment are described below.

At time of image formation, a predetermined voltage is applied to charging rollers 14Y, 14M, 14C, and 14K (hereinafter collectively referred to as the “charging roller 14”) from a power supply (not shown). The charging roller 14 charges the surface of the photoconductive drum 11 disposed facing the charging roller 14. The optical writing unit 3 irradiates a light beam onto the surface of the photoconductive drum 11 charged to a predetermined electric potential level based on image data to write an electrostatic latent image onto the surface of the photoconductive drum 11. When the electrostatic latent image formed on the surface of the photoconductive drum 11 reaches the development device 10, the development roller disposed facing the photoconductive drum 11 supplies a toner to the electrostatic latent image on the surface of the photoconductive drum 11 to form a toner image thereon. Such an operation is performed by photoconductive units 2Y, 2M, 2C, and 2K in a similar manner at a predetermined timing, respectively, and a toner image of a predetermined color is formed on each of the surfaces of the photoconductive drums 11Y, 11M, 11C, and 11K.

The recording sheet 100 is fed from any one of the paper feed cassettes 4a, 4b, and the manual paper feed tray MF, and the conveyance of the recording sheet 100 is temporarily stopped when the recording sheet 100 reaches a pair of registration rollers 5. Then, the recording sheet 100 is fed from a pair of the registration rollers 5 at a timing corresponding to the image forming operation performed by the photoconductive units 2Y, 2M, 2C, and 2K. The toner images on the surfaces of the photoconductive drums 11Y, 11M, 11C, and 11K are sequentially transferred onto the recording sheet 100 which has passed a pair of the registration rollers 5 while the conveyance belt 60 conveys the recording sheet 100. The toner images are transferred onto the recording sheet 100 by application of a voltage, having a polarity opposite to a polarity of the toner on the photoconductive drums 11Y, 11M, 11C, and 11K, from the power supply (hot shown) to primary transfer rollers 67Y, 67M, 67C, and 67K disposed facing the photoconductive drums 11Y, 11M, 11C, and 11K, respectively across the conveyance belt 60. After the recording sheet 100 has passed a position opposite to the photoconductive drum 11K, the toner images of the four colors are superimposed one on another on the recording sheet 100. Then, the recording sheet 100 is conveyed to the fixing unit 7, and heat and pressure are applied to the recording sheet 100 to fix the toner images thereon.

The image forming apparatus of the first example embodiment includes a boundary detection sensor, not shown, for detecting a boundary between the transparent portion 26 and the non-transparent portion 28 of the recording sheet 100. The boundary detection sensor, for example, is a transmissive photosensor including a light emitting part for emitting light to a conveyance surface of the recording sheet, and a light receiving part disposed opposite to the light emitting part for detecting the light from the light emitting part. The boundary detection sensor senses a light reception signal in the light receiving part with a control unit to detect the boundary between the transparent portion 26 and the non-transparent portion 28 of the recording sheet 100. The control unit performs an image forming operation with the signal received by the light receiving part as a writing trigger.

An image may be formed at a desired position on the transparent portion 26 of the recording sheet 100 with the boundary detection sensor not only in the case where the boundary between the transparent portion 26 and the non-transparent portion 28 is placed at the center of the recording sheet 100 as shown in FIG. 1A, but also in the case where a part of the recording sheet 100 is transparent as shown in FIG. 1B, or the transparent portion 26 is smaller than the non-transparent portion 28 as shown in FIG. 4. A reflective photosensor may be used as the boundary detection sensor. In such a case, the boundary between the transparent portion 26 and the non-transparent portion 28 may be detected from a difference in reflectivity between the transparent portion 26 and the non-transparent portion 28. The boundary detection sensor may be provided on a downstream side in a conveyance direction of a pair of the registration rollers 5. In this case, a detection error caused by a difference in an amount of slack in a pair of the registration rollers 5 or a diagonal shift on the leading edge of the recording sheet 100 is not likely to occur. As a result, the boundary of the transparent portion 26 and the non-transparent portion 28 may be accurately detected.

The control unit inverts the image data read by a reading device to form a mirror image obtained by horizontally or vertically inverting an original image. Then, the optical writing unit 3 writes data of the inverted image onto the surface of the photoconductive drum 11 as an electrostatic latent image. The inverted image is transferred onto the recording sheet 100 to form an image on the transparent portion 26.

Thus, the original image is horizontally or vertically inverted to form the image on the surface of the transparent portion 26 of the recording sheet 100 as described above. Then, as shown in FIG. 4, the recording sheet 100 is folded back along the boundary to superimpose the transparent portion 26 and the non-transparent portion 28. As a result, a normal non-inverted image may be obtained by rotating the recording sheet 100 upside down.

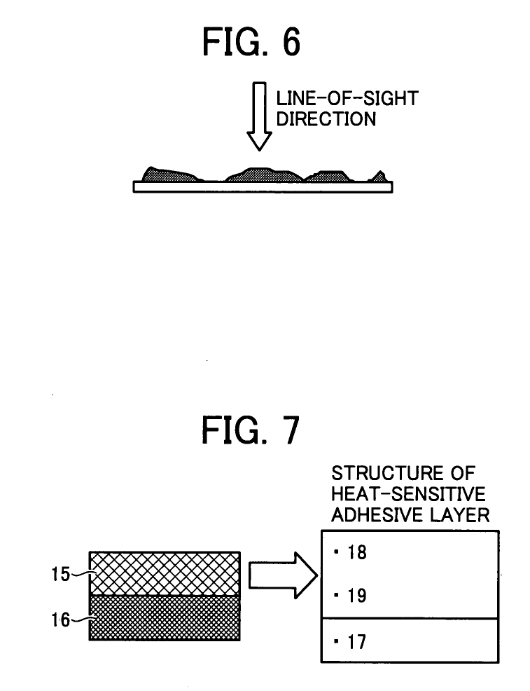

FIGS. 5A and 5B are cross-sectional views illustrating a structure of the recording sheet 100 used in the first example embodiment. FIG. 5A illustrates a cross-section of the recording sheet 100 being folded (a cross-section along A-A′ in FIG. 2C), and FIG. 5B illustrate a cross-section of the recording sheet 100 being heated and pressed (a cross-section along B-B′ in FIG. 2E). As shown in FIG. 5A, the folded recording sheet 100 is output in a form including the toner image 27 between the transparent portion 26 and the non-transparent portion 28. As shown in FIG. 5B, the transparent portion 26 and the non-transparent portion 28 between which a toner image 29 is placed, are superimposed, and are applied with heat and pressure to obtain the image on the recording sheet 100. Since the recording sheet 100, is to be folded, the image is printed in an inverted manner so that the image is viewed from the back side of the recording sheet 100 via the transparent portion 26 as shown in FIG. 5B. Since a printed image is normally viewed from a toner surface with unevenness as shown in FIG. 6, the printed image has no smoothness. Since the image formed by the image forming apparatus according to the first example embodiment is viewed via the transparent portion 26 without unevenness, a smooth image may be obtained. Moreover, the obtained image looks like a photograph due to a combination of a flat surface of the image and reflective light from the surface of the transparent portion 26.

The heat-sensitive adhesive layer is now described in detail, with reference to FIG. 7.

As shown in FIG. 7, a heat-sensitive adhesive layer 15 includes two layers. A top layer includes a solid plasticizer 17 and a thermoplastic resin emulsion (e.g., an acrylic emulsion) 18, both of which are essential components of the heat-sensitive adhesive layer 15. A bottom layer includes a tackifier 19 and so forth. The heat-sensitive adhesive layer 15 is applied on a base medium 16 serving as a support to form a heat-sensitive adhesive medium shown in FIG. 7. The surface of the heat-sensitive adhesive layer 15 does not provide adhesion at room temperature, but does provide adhesion when heated. Even after a heat source is removed, the surface of the heat-sensitive adhesive layer 15 may provide adhesion for a while (or, adhesion remains semi-permanent at room temperature). When the heat-sensitive adhesive layer 15 is heated, the solid plasticizer 17 is melted and the thermoplastic resin emulsion 18 and the tackifier 19 are dissolved, providing adhesion. Such a heat-sensitive adhesive layer typically does not include a peel-and-stick sheet generally used as an adhesive material, resulting in resource saving and environmental protection. Moreover, when a heat-sensitive adhesive material is heated while the heat-sensitive adhesive layer 15 abuts an adherend, the heat-sensitive adhesive layer 15 is adhered to the adherend, preventing or reducing adhesion errors.

When the solid plasticizer 17 includes at least one of compounds including a benzoate group, a benzophenone group, a phenylenediamine group, and a benzothiazole group, the solid plasticizer 17 provides increased adhesion at low temperature. Specific examples of the compound including the benzoate group include a compound 1 shown in Table 1 below, specific examples of the compound including the benzophenone group include compounds 2, 3, and 4 shown in Table 1 below, specific examples of the compound including the phenylenediamine group include compounds 5 and 6 shown in Table 1 below, and specific examples of the compound including the benzothiazole group include compounds 7, 8, 9, 10, and 11 shown in Table 1 below. It should be noted that the compounds including the benzoate group, the benzophenone group, the phenylenediamine group, and the benzothiazole group are not limited to the above. The compound 1 including the benzoate group, the compound 2 including the benzophenone group, the compound 5 including the phenylenediamine group, and the compound 7 including the benzothiazole group especially provide increased adhesion in an environment of low temperature, because these compounds have an increased compatibility with the thermoplastic resin and the tackifier.

TABLE 1

| | |
|---|---|
| Compound 1Melting point: 151degrees centigradeSymmetry number: 1 | 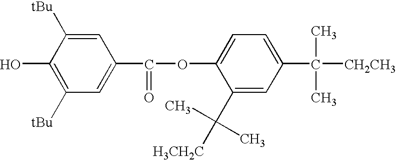 |
| Compound 2Melting point: 115degrees centigradeSymmetry number: 1 | 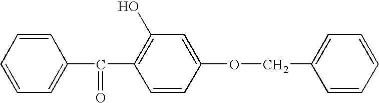 |
| Compound 3Melting point: 142degrees centigradeSymmetry number: 1 | 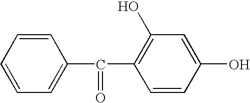 |
| Compound 4Melting point: 110degrees centigradeSymmetry number: 1 | 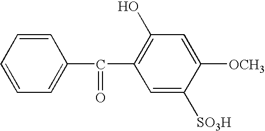 |
| Compound 5Melting point: 115degrees centigradeSymmetry number: 1 | 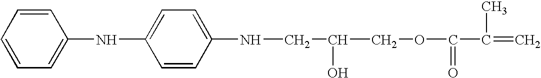 |
| Compound 6Melting point: 140degrees centigradeSymmetry number: 1 | 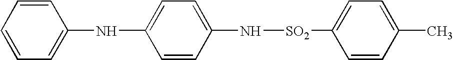 |
| Compound 7Melting point: 123degrees centigradeSymmetry number: 1 | 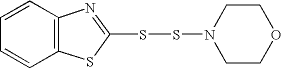 |
| Compound 8Melting point: 95degrees centigradeSymmetry number: 1 | 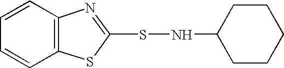 |
| Compound 9Melting point: 150degrees centigradeSymmetry number: 1 | 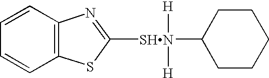 |
| Compound 10Melting point: 155degrees centigradeSymmetry number: 1 | 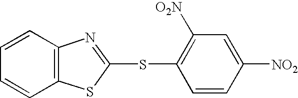 |
| Compound 11Melting point: 95degrees centigradeSymmetry number: 1 | 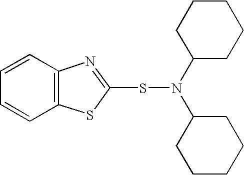 |
| Compound 12Melting point: 148degrees centigradeSymmetry number: 1 | 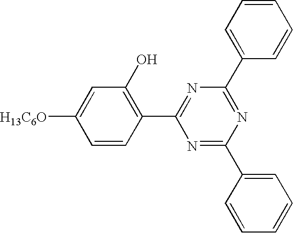 |
| Compound 13Melting point: 95.5degrees centigradeSymmetry number: 1 | 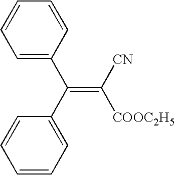 |

The following describes the thermoplastic resin emulsion 18 included in the heat-sensitive adhesive layer 15. However, any other known thermoplastic resin emulsion may be used. Specific examples of the thermoplastic resin emulsion 18 include, but are not limited to, an acrylic ester copolymer, a methacrylic ester copolymer, a styrene-isoprene copolymer, a styrene-acrylic ester copolymer, a styrene-butadiene copolymer, an acrylonitrile-butadiene copolymer, an ethylene-vinyl acetate copolymer, a vinyl acetate-acrylic ester copolymer, an ethylene-vinyl chloride copolymer, an ethylene-acrylic ester copolymer, a vinyl acetate-ethylene-vinyl chloride copolymer, a vinyl acetate-ethylene-acrylic ester copolymer, a vinyl acetate-ethylene-styrene copolymer, a polybutadiene, and a polyurethane. For example, when the heat-sensitive adhesive layer 15 includes the acrylic ester copolymer as the thermoplastic resin emulsion 18, the heat-sensitive adhesive layer 15 may provide an increased adhesion. Especially, the heat-sensitive adhesive layer 15 may preferably include 2-ethylhexyl acrylate which provides an increased adhesion.

The tackifier 19 may be added to the heat-sensitive adhesive layer 15 to increase adhesion thereof. Specific examples of the tackifier 19 include, but are not limited to, a terpene resin, an aliphatic petroleum resin, an aromatic petroleum resin, a coumarone-indene resin, a styrene resin, a phenolic resin, a terpene phenolic resin, and a rosin derivative resin. The heat-sensitive adhesive layer 15 includes the tackfier 19 in an amount of not greater than 2.0 parts by weight, and preferably from 0.2 to 1.5 parts by weight, based on 1.0 part by weight of the thermoplastic resin emulsion 18. When the amount of the tackifier 19 is too large, blocking may easily occur.

When an anti-blocking agent is added to the heat-sensitive adhesive layer 15, the occurrence of blocking may be prevented in a high temperature environment. The anti-blocking agent includes a wax and an inorganic filler, examples of the wax and the inorganic filler are described below. It should be noted that the anti-blocking agent is not limited to the following.

Specific examples of the wax include, but are not limited to, waxes (e.g., animal and plant waxes, synthetic wax, and the like), a higher fatty acid, N-hydroxymethyl stearic acid amide, higher fatty acid amide other than stearic acid amide, higher fatty acid anilide, an acetyl compound of aromatic amine, paraffin wax, Japan wax, carnauba wax, shellac, montan wax, paraffin oxide, polyethylene wax, and polyethylene oxide. Specific examples of the higher fatty acid include, but are not limited to, a stearic acid and a behenic acid. Specific examples of the higher fatty acid amide include, but are not limited to, stearic acid amide, oleic acid amide, N-methyl stearic acid amide, erucic acid amide, methylol behenic acid amide, methylol stearic acid amide, methylene bis stearic acid amide, and ethylene bis stearic acid amide. Specific examples of the higher fatty acid anilide include, but are not limited to, stearic acid anilide and linoleic acid anilide. Specific examples of the acetyl compound of aromatic amine include, but are not limited to, acetotoluidide. Specific examples of a heat melting material other than wax include, but are not limited to, a leuco dye and a developer generally used as a thermal recording material. The heat melting material, including a wax, may preferably have a high melting point so that the heat melting material and the wax do not affect adhesion of the adhesive layer.

Specific examples of the inorganic filler include, but are not limited to, a carbonate, an oxide, a hydroxide, and a sulfate of aluminum, zinc, calcium, magnesium, barium, and titan; an inorganic pigment including clays (e.g., natural silica, zeolite, kaolin, calcined kaolin, and the like). The inorganic filler may preferably have a low oil-absorb amount so that the inorganic filler may not affect adhesion of the heat-sensitive adhesive layer 15. The thermoplastic resin emulsion 18 includes the anti-blocking agent in an amount of not greater than 1.5 parts by weight, and preferably from 0.6 to 1.0 parts by weight, based on 1.0 part by weight of the thermoplastic resin emulsion 18. When the amount of the anti-blocking agent is too large, adhesion may easily decrease.

To increase adhesion between the heat-sensitive adhesive layer 15 and the base medium 16, or to increase cohesion in the heat-sensitive adhesive layer 15, the heat-sensitive adhesive layer 15 may include an aqueous polymer binder. Specific examples of the aqueous polymer binder include, but are not limited to, polyvinyl alcohol, polyvinyl acetate, starch oxide, etherified starch, a cellulose derivative (e.g., carboxy methyl cellulose, hydroxy ethyl cellulose, and the like), casein, gelatin, and alginic soda. The aqueous polymer binder is added in an amount that does not decrease the original adhesion of the heat-sensitive adhesive layer 15. For example, the heat-sensitive adhesive layer 15 includes the aqueous polymer binder in an amount of not greater than 30 weight percent, and preferably not greater than 10 weight percent, based on total weight of the heat-sensitive adhesive layer 15 on a solid basis. In addition to the above-described components, various additives (e.g., a hardener, a preservative, a dye, a developer, a pH adjuster, an antifoaming agent, and the like) may be added as needed to the heat-sensitive adhesive layer 15.

The heat-sensitive adhesive layer 15 is formed on one portion of the recording sheet 100 which is to be superimposed on the other portion of the recording sheet 100 having an image. Since the heat-sensitive adhesive layer 15 has no adhesion at room temperature, the recording sheet 100 may be stacked in the paper feed trays, and the recording sheet 100 may be easily conveyed without a particular release layer. Moreover, positional alignment may be easily performed when the one portion of the recording sheet 100 including the heat-sensitive adhesive layer 15 is superimposed on the other portion of the recording sheet 100 having a toner image. Since the heat-sensitive adhesive layer 15 has adhesion when heated, the one portion of the recording sheet 100 including the heat-sensitive adhesive layer 15 and the other portion of the recording sheet 100 having a toner image, the positions of which have been aligned, are heated to be bonded to each other.

The melting points of the solid plasticizer 17 and the thermoplastic resin emulsion 18 included in the heat-sensitive adhesive layer 15 are lower than the melting point of a toner. When the heating process described above is performed at a temperature between the melting points of the solid plasticizer 17 and the thermoplastic resin emulsion 18, and the melting point of the toner, the portion of the recording sheet 100 including the heat-sensitive adhesive layer 15 and the other portion of the recording sheet 100 having a toner image may adhere to each other without image deterioration caused by melting of the toner.

The heat-sensitive adhesive layer 15 used in the recording sheet 100 according to the first example embodiment requires a short time and low pressure for fixing a toner image. Therefore, the image forming apparatus according to the first example embodiment may be adjusted such that the heat-sensitive adhesive layer 15 does not effectively serve as an adhesive agent in a short time even when the fixing temperature exceeds the softening temperature or the melting point of the thermoplastic resin emulsion 18 included in the heat-sensitive adhesive layer 15. When the toner image is fixed, a heat applying surface of a fixing roller preferentially contacts the toner image and melts the toner to fix the toner image. Then, the toner image contacts the heat-sensitive adhesive layer 15 so that the toner image strongly adhered to the heat-sensitive adhesive layer 15 may be obtained, providing a mirror image. In the recording sheet 100 having the mirror image obtained as described above, the toner is not melted by heat although the heat-sensitive adhesive layer 15 is melted by heat. Accordingly, the fixed toner image does not move even when heat is applied to the heat-sensitive adhesive layer 15. In addition to heat, pressure is applied to the heat-sensitive adhesive layer 15 so that the toner image is fixed onto the recording sheet 100.

As described above, the sheet processing method according to the first example embodiment uses a recording sheet including a recordable portion and an adhesive portion at least in a part thereof. The recording sheet further includes a transparent portion and a non-transparent portion. The recordable portion and the adhesive portion may be bonded together by folding the recording sheet, so that at least a part of an image printed on the recordable portion may be viewed from the transparent portion. More specifically, the transparent portion, which is included in one portion of the recording sheet capable of being fed in an image forming apparatus, and the other portion of the recording sheet having a heat-sensitive adhesive layer are integrated after an image has been formed on the transparent portion. Accordingly, the recording sheet having high storage stability and conveyance performance, wherein positional alignment of the transparent portion having an image and the non-transparent portion having an heat-sensitive adhesive layer may be easily performed, may be provided, and a photographic image having a satisfactory storage life may be formed thereon. Furthermore, an image forming apparatus capable of forming an image on such a recording sheet may be provided.

The recording sheet includes a transparent portion at least in a part thereof, and an image is formed thereon. Since a surface of the transparent portion having the image covers the recording sheet like a film, the recording sheet with a flat, smooth, and glossy photographic image may be obtained.

An image obtained by horizontally or vertically inverting an original image is formed on the recording sheet including a transparent portion at least in a part thereof. Accordingly, the recording sheet with a regular, non-inverted image may be output.

The transparent portion having an image and the non-transparent portion having a heat-sensitive adhesive layer are arranged side by side on a sheet, and both portions are bonded together by folding the sheet. Therefore, the image forming apparatus need not include paper feed and conveyance systems.

The heat-sensitive adhesive layer includes at least a thermoplastic resin and a solid plasticizer, and further includes an adhesive agent as needed. The heat-sensitive adhesive layer does not provide adhesion at room temperature, but does provide adhesion when heated. Accordingly, the heat-sensitive adhesive layer may provide semi-permanent adhesion after bonding.

The melting points of the thermoplastic resin and the solid plasticizer are lower than the melting point of a toner. Therefore, when an image is fixed onto the recording sheet by using the toner, application of heat to the heat-sensitive adhesive layer to increase adhesion does not cause image deterioration. As a result, the recording sheet with a photographic image may be obtained without a cost increase.

The following description refers to a sheet processing method and an image forming apparatus according to a second example embodiment, in which a transparent sheet and a non-transparent sheet prepared separately from each other are bonded together after an image has been formed on the transparent sheet to obtain a photographic image.

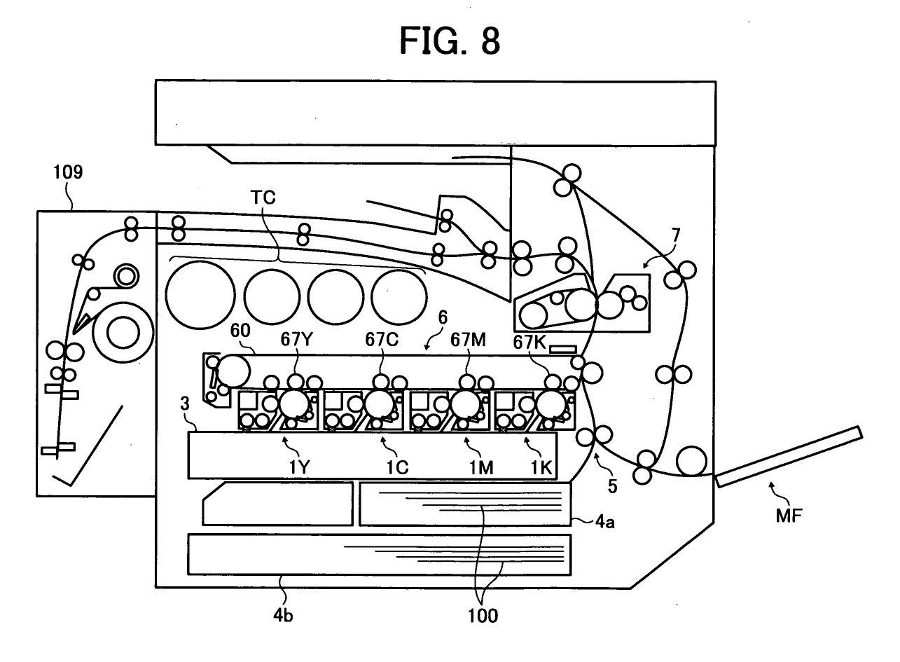

FIG. 8 is a schematic cross-sectional view illustrating a structure of an image forming apparatus according to the second example embodiment. The image forming apparatus includes a transfer unit 6 having a primary transfer unit and a secondary transfer unit, and further includes a bonding device 109 serving as a post-processing device. Arrangement of units and devices in the image forming apparatus according to the second example embodiment is different from the arrangement of units and devices in the image forming apparatus according to the first example embodiment shown in FIG. 1. However, since a function of each component and an image forming operation of both image forming apparatuses are the same, descriptions thereof are omitted. In the second example embodiment, a transparent sheet and a non-transparent sheet are not integrally formed. Therefore, a boundary between the transparent portion and the non-transparent portion is not required to be detected. Accordingly, a boundary detection sensor may not be installed. An image is formed on the transparent sheet in a similar manner as image formation on a normal recording medium.

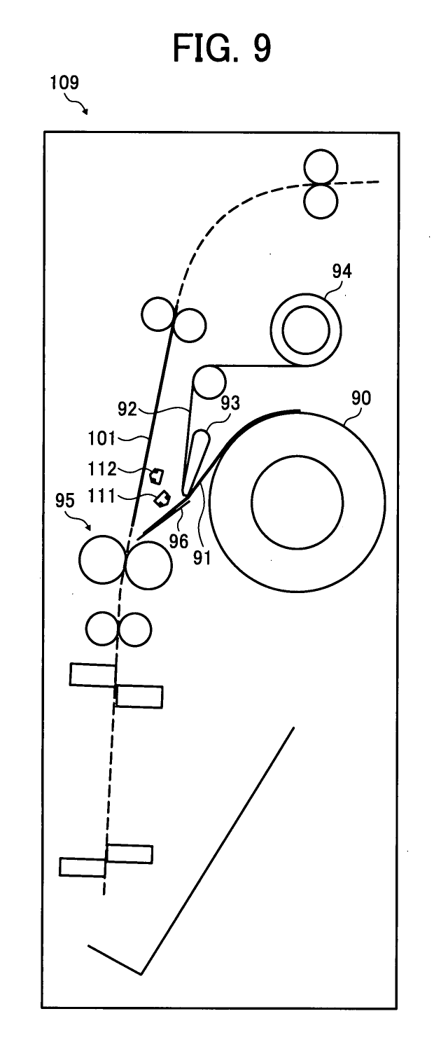

FIG. 9 is a schematic cross-sectional view illustrating a structure of the bonding device 109 serving as a post-processing device of the image forming apparatus according to the second example embodiment. A non-transparent sheet 91 including an adhesive layer is cut into predetermined size, and is rewound on a non-transparent sheet roll 90. A separation plate 93 removes release paper 92 from the non-transparent sheet 91 by using curvature, and the removed release paper 92 is rewound on a release paper rewinding roller 94. Sensors 111 and 112 capable of detecting a transparent sheet 101 and the non-transparent sheet 91 are disposed at the front of a pair of pressing rollers 95. The bonding device 109 may precisely adjust a leading edge of each of the transparent sheet 101 and the non-transparent sheet 91 in accordance with a signal from the sensors 111 and 112.

A guide member 96 for controlling a position of the non-transparent sheet 91 is disposed between a position where the release paper 92 is removed from the non-transparent sheet 91 and a position where the transparent sheet 101 and the non-transparent sheet 91 are bonded together. The non-transparent sheet 91 is led to the pair of the pressing rollers 95 along the guide member 96. The guide member 96 is pressed by a spring, not shown, or includes an elastic material. Therefore, the guide member 96 is retracted when a force pulling the pair of the pressing rollers 95 occurs, and does not disturb the pressing process.

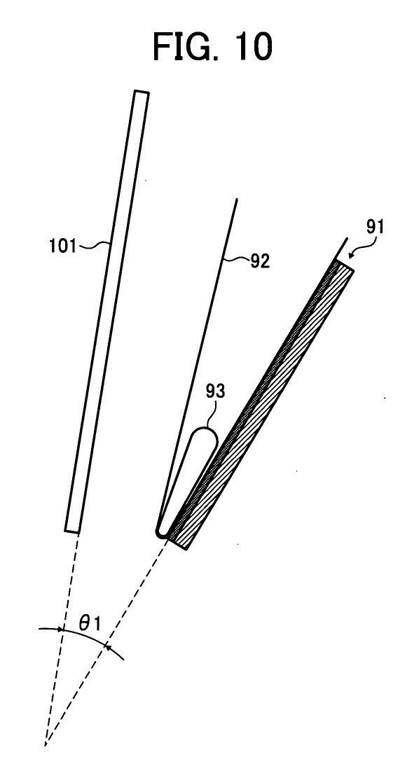

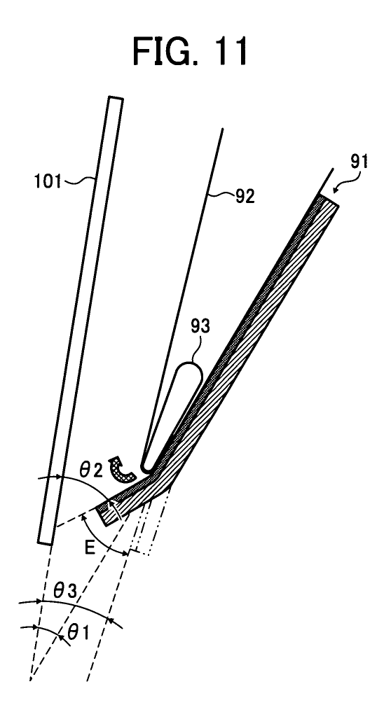

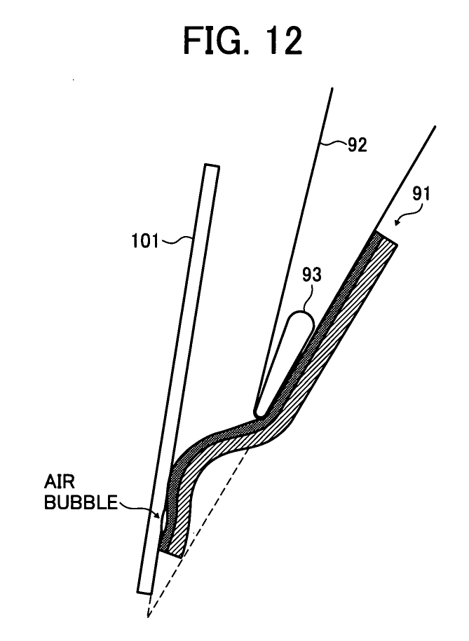

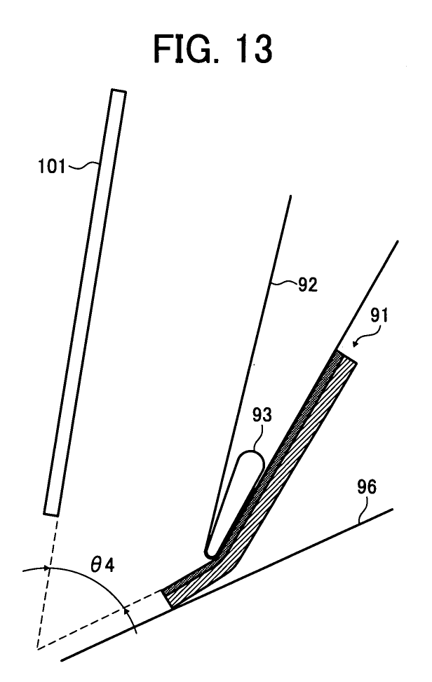

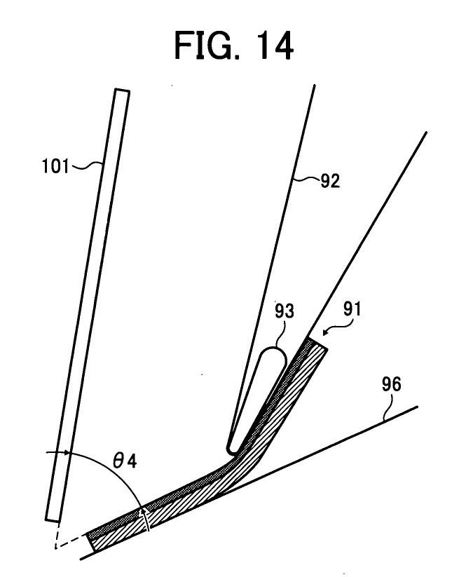

FIGS. 10 to 17 illustrate states in which the non-transparent sheet 91 is bonded to the transparent sheet 101. After passing the separation plate 93, a conveyance direction of the non-transparent sheet 91 is not controlled and varies in a range indicated by an arrow E in FIG. 11. Therefore, a bonding angle may vary in a range between θ3, which is equal to or less than a bonding angle θ1 shown in FIG. 10, and θ2, which is equal to or greater than the bonding angle θ1. As a result, the non-transparent sheet 91 and the transparent sheet 101 are bonded together in an undesired manner, causing wrinkles or air bubbles between the non-transparent sheet 91 and the transparent sheet 101 as shown in FIG. 12. To solve this problem, a mounting angle (θ4) of the guide member 96 is set to be equal to or greater than θ2 as shown in FIGS. 13 and 14, so that the bonding angle θ1 becomes equal to the mounting angle θ4, providing a constant bonding angle. Consequently, the non-transparent sheet 91 and the transparent sheet 101 may be properly bonded together.

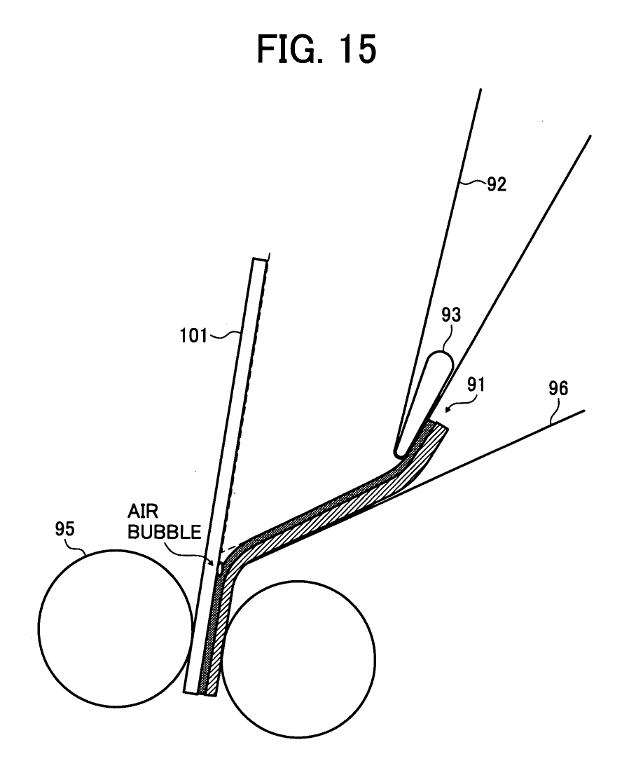

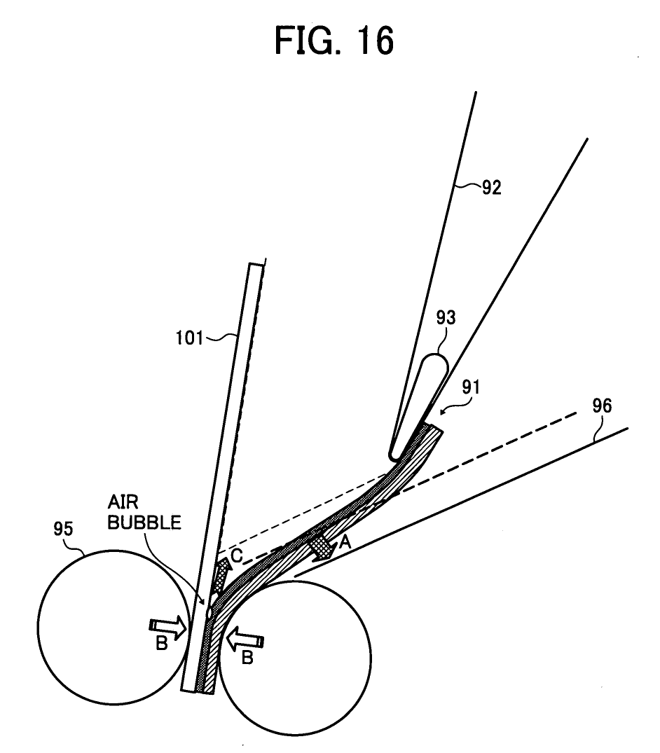

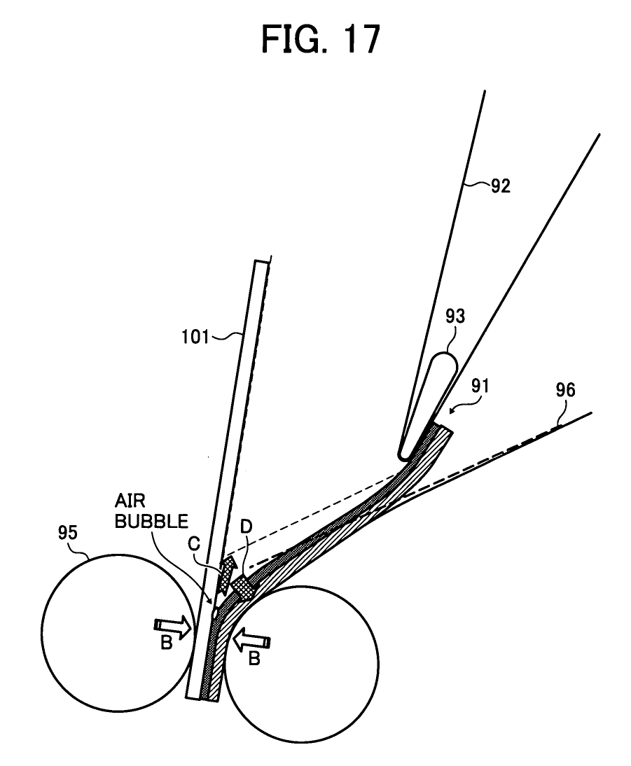

When the guide member 96 is fixed and may not be retracted, not only the non-transparent sheet 91 is curved when pressed by the pair of the pressing rollers 95, but also the non-transparent sheet 91 and the transparent sheet 101 contact each other before being pressed as shown in FIG. 15. Therefore, small air bubbles are likely to occur between the non-transparent sheet 91 and the transparent sheet 101. To solve the above problems, the guide member 96 may be retracted in directions indicated by arrows A and D shown in FIGS. 16 and 17 respectively, by being pressed by the spring (not shown) and including an elastic material. Since the pair of the pressing rollers 95 presses the non-transparent sheet 91 and the transparent sheet 101 at a nip portion in directions indicated by arrows B, the air bubbles are removed in a direction indicated by an arrow C with such a configuration.

The present invention has been described above with reference to specific example embodiments. Nonetheless, the present invention is not limited to the details of example embodiments described above, and various modifications and improvements are possible without departing from the spirit and scope of the present invention. It is therefore to be understood that, within the scope of the associated claims, the present invention may be practiced otherwise than as specifically described herein. Thus, for example, elements and/or features of different illustrative example embodiments may be combined with each other and/or substituted for each other within the scope of the present invention.

For example, an LED may be used for a writing system instead of using a laser beam, and a one-component development system may be used instead of using a two-component development system. As a fixing means, rollers or inductive heaters may be used in place of a belt. Furthermore, an electrophotographic system, or any other system such as an inkjet system, may be adopted in the image forming apparatus according to the present invention.

As described in the foregoing example embodiments, a recording sheet with an image may be obtained in the structure shown in FIG. 5B, either by folding a recording sheet including a transparent portion and a non-transparent portion, or by bonding a transparent sheet and a non-transparent sheet, each of which is separately prepared.

What is claimed is:

1. A sheet processing method, comprising superimposing a transparent sheet having a mirror image thereon on a non-transparent sheet, so that a surface of the transparent sheet having the mirror image faces the non-transparent sheet with an adhesive medium therebetween.

2. The sheet processing method according to claim 1, further comprising pressing the transparent sheet and the non-transparent sheet with the adhesive medium therebetween.

3. The sheet processing method according to claim 2, further comprising heating the transparent sheet and the non-transparent sheet with the adhesive material therebetween.

4. The sheet processing method according to claim 1, wherein the non-transparent sheet comprises a heat-sensitive adhesive layer comprising an adhesive medium comprising a thermoplastic resin and a solid plasticizer, on a surface facing the surface of the transparent sheet having the mirror image.

5. The sheet processing method according to claim 4, wherein each of the thermoplastic resin and the solid plasticizer has a lower melting point than that of a toner used for forming the mirror image.

6. The sheet processing method according to claim 1, wherein the transparent sheet and the non-transparent sheet are integrally formed in a single sheet.

7. The sheet processing method according to claim 6, further comprising folding the integrally-formed sheet comprising the transparent sheet portion and the non-transparent sheet portion, so that a surface of the transparent sheet portion having the mirror image faces the non-transparent sheet portion with the adhesive medium therebetween.

8. The sheet processing method according to claim 1, further comprising forming the mirror image on the surface of the transparent sheet facing the non-transparent sheet.

9. An image forming apparatus, comprising:
an image forming means for forming a mirror image on a transparent sheet; and
a heating and pressing means for applying heat and pressure to the transparent sheet and a non-transparent sheet which are superimposed so that a surface of the transparent sheet having the mirror image faces the non-transparent sheet,
wherein the non-transparent sheet comprises a heat-sensitive adhesive layer comprising an adhesive medium comprising a thermoplastic resin and a solid plasticizer, on a surface facing the surface of the transparent sheet having the mirror image.
